(19) United States
(12) Patent Application Publication
(10) Pub. No.: US 2022/0149364 A1
(43) Pub. Date: May 12, 2022

(54) POSITIVE ELECTRODE MATERIAL FOR LITHIUM SECONDARY BATTERY AND LITHIUM SECONDARY BATTERY INCLUDING THE SAME

(71) Applicants: HYUNDAI MOTOR COMPANY, Seoul (KR); KIA CORPORATION, Seoul (KR); INDUSTRY ACADEMY COOPERATION FOUNDATION OF SEJONG UNIVERSITY, Seoul (KR)

(72) Inventors: Seung Min Oh, Incheon (KR); Yoon Sung Lee, Suwon-si (KR); Ji Eun Lee, Hwaseong-si (KR); Sang Mok Park, Gwangju-si (KR); Sung Ho Ban, Hwaseong-si (KR); Woo Young Jin, Busan (KR); Sang Hun Lee, Paju-si (KR); Seung Taek Myung, Seoul (KR); Ji Ung Choi, Seoul (KR)

(21) Appl. No.: 17/339,111

(22) Filed: Jun. 4, 2021

(30) Foreign Application Priority Data
Nov. 10, 2020 (KR) 10-2020-0149454

(51) Int. Cl. H01M 4/505; H01M 10/0525

(52) U.S. Cl. CPC H01M 4/505; H01M 2004/028; H01M 10/0525

(57) ABSTRACT

Disclosed herein is a positive electrode material for a lithium secondary battery, which has a high energy density with only a single positive electrode material, and a lithium secondary battery including the same. A positive electrode active material is made of Li—[Mn—Ti]—O-based material and doped with Al.

### CROSS REFERENCE TO RELATED APPLICATIONS

The present application claims priority of Korean Patent Application No. 10-2020-0149454 filed on Nov. 10, 2020, the entire contents of which is incorporated herein for all purposes by this reference.

### BACKGROUND

### Field of the Disclosure

The present disclosure relates to a positive electrode material for a lithium secondary battery and a lithium secondary battery including the same, and more particularly, to a positive electrode material for a lithium secondary battery, which has a high energy density with only a single positive electrode material, and a lithium secondary battery including the same.

### Description of the Related Art

Lithium secondary batteries are used as power supply sources of smart phones, notebook computers, hybrid vehicles, and electric vehicles. The lithium secondary battery is rechargeable and has advantages of a high energy density, a high output, and a high speed charging when compared with the existing lead batteries and nickel hydride batteries.

A lithium secondary battery includes a positive electrode which provides lithium during charging, a negative electrode which accepts the lithium, an electrolyte which is a transfer path of a lithium ion, and a separator which separates the positive electrode from the negative electrode to prevent a contact therebetween. The lithium ion stored in the negative electrode is deintercalated, and when the lithium ion is intercalated to the positive electrode, electrical energy is generated due to a change in chemical potential.

In the lithium secondary battery, when charging and discharging are repeated, structures of the positive electrode and the negative electrode are varied so that a variation occurs in the capacity and output of the lithium secondary battery, and it is difficult to maintain the same performance as in an initial stage. Thus, it is very importance to stably maintain an interface between the positive electrode and the negative electrode so as to secure a long lifetime and reliability of the lithium secondary battery.

As described above, in order to improve performance of the lithium secondary battery, research on improving a positive electrode material is continuously being conducted. In particular, research is being conducted so as to develop a high performance and high safety lithium secondary battery. However, as recently explosion accidents of lithium secondary batteries occur frequently, safety issues have been continuously raised.

Therefore, the present applicants completed the present disclosure by understanding that, when a lithium excess material is used, a high capacity of 250 mAh/g or more can be implemented in a voltage range of 2 V to 4.2 V to implement a high energy density lithium secondary battery.

The foregoing is intended merely to aid in understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to propose a positive electrode material for a lithium secondary battery, which is capable of implementing a discharge capacity that is greater than a discharge capacity of a conventional positive electrode by doping a transition metal without using nickel (Ni) and cobalt (Co), and a lithium secondary battery including the same.

According to one aspect, there is provided a positive electrode material for a lithium secondary battery, wherein the positive electrode material may be a positive electrode active material made of Li—[Mn—Ti]—O-based material to allow reversible intercalation and reversible deintercalation of Li, and the positive electrode active material may be doped with a dopant (Me) having bivalent to hexavalent oxidation numbers.

The positive electrode material may be Li_{1.25+y}[Mn_{0.45}Ti_{0.35}]₁₋ₓMeₓO₂, the dopant (Me) may be aluminum (Al), and 0.025≤x≤0.05 and −0.02≤y≤0.02 may be satisfied.

According to another aspect, there is provided a lithium secondary battery including a positive electrode active material made of Li—[Mn—Ti]—O-based material to allow reversible intercalation and reversible deintercalation of Li, a positive electrode including the positive electrode material doped with the dopant (Me), a negative electrode including a negative electrode active material, and an electrolyte.

### BRIEF DESCRIPTION OF THE FIGURES

The above and other objects, features and other advantages of the present disclosure will be more clearly understood from the following detailed description when taken in conjunction with the accompanying drawings, in which:

FIG. 1 is a graph showing results of X-ray diffraction (XRD) analysis of positive electrode materials according to Comparative Examples and Examples of the present disclosure;

FIG. 2 shows scanning electron microscope (SEM) photographs illustrating the positive electrode materials according to Comparative Examples and Examples of the present disclosure;

FIGS. 3A, 3B, 3C, and 3D are graphs showing results of evaluating battery capacities among electrochemical characteristics of the positive electrode materials prepared according to Comparative Examples and Examples of the present disclosure;

FIGS. 4A, 4B, 4C, and 4D are graphs showing results of evaluating the battery capacities according to cycles of batteries using positive electrodes which are manufactured according to Comparative Examples and Examples of the present disclosure; and

FIG. 5 is a graph showing comparison results of initial capacity retention rates according to the cycles of the batteries using the positive electrodes which are manufactured according to Comparative Examples and Examples of the present disclosure.

### DETAILED DESCRIPTION

Hereinafter, exemplary embodiments of the present disclosure will be described in more detail with reference to the accompanying drawings. However, the present disclosure may be embodied in many different forms and should not be construed as being limited to the embodiments set forth herein. Rather, these embodiments are provided such that this disclosure will be thorough and complete and will fully convey the scope of the present disclosure to those skilled in the art.

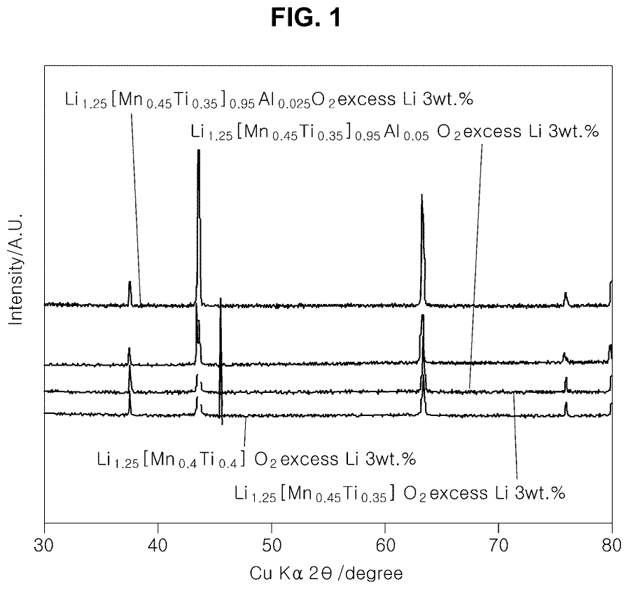

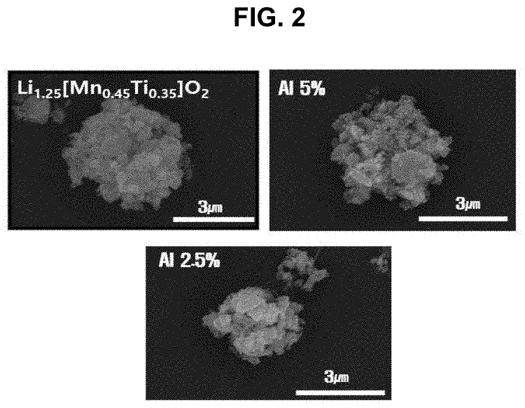

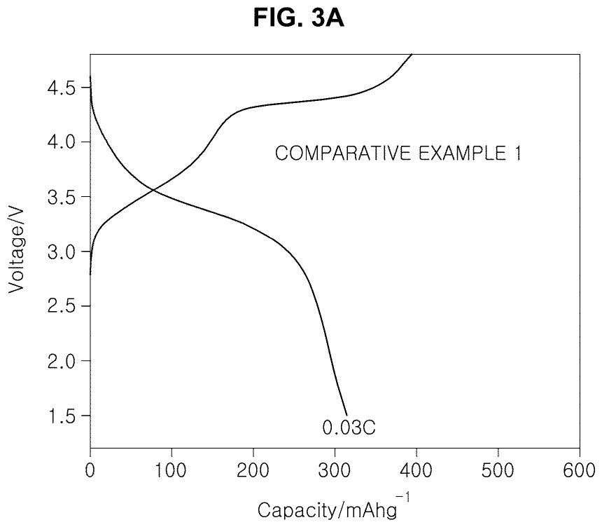

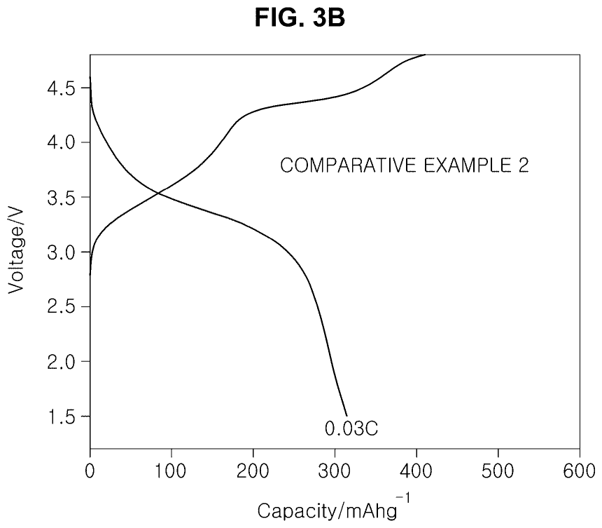

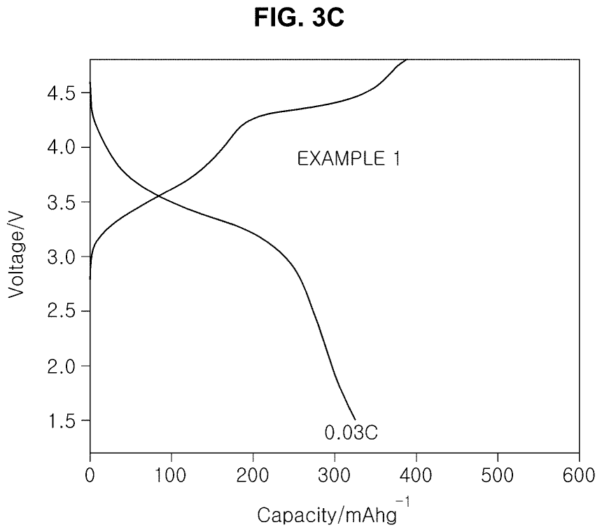

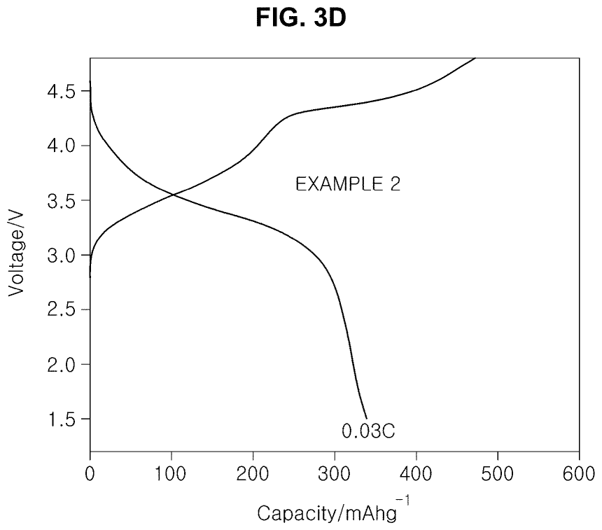

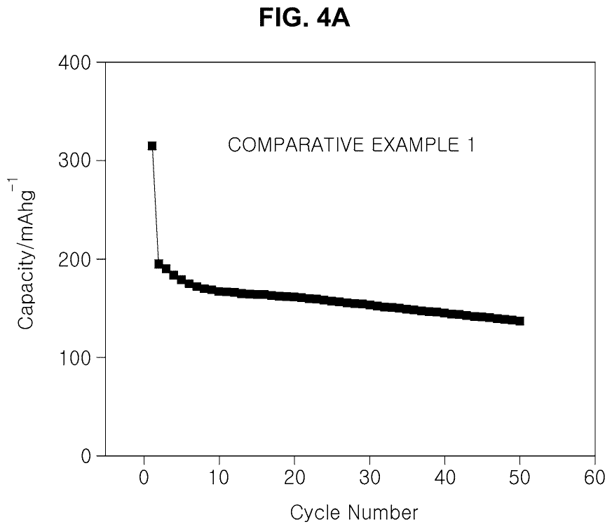

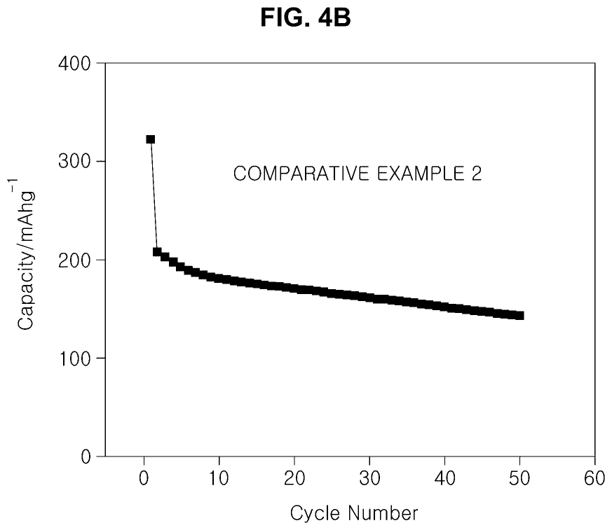

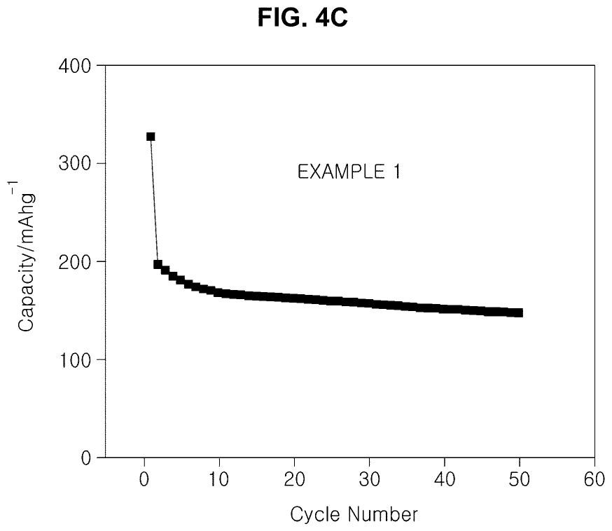

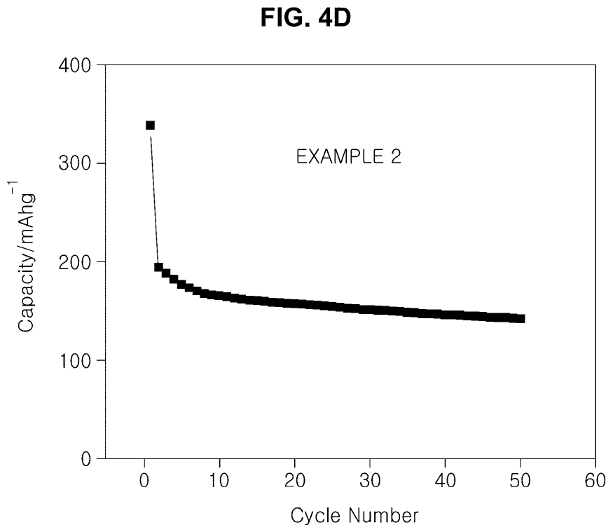

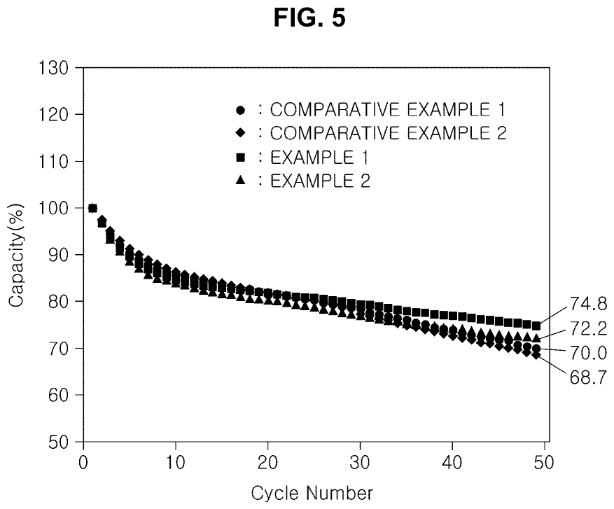

FIG. 1 is a graph showing results of X-ray diffraction (XRD) analysis of positive electrode materials according to Comparative Examples and Examples of the present disclosure, FIG. 2 shows scanning electron microscope (SEM) photographs illustrating the positive electrode materials according to Comparative Examples and Examples of the present disclosure, FIGS. 3A to 3D are graphs showing results of evaluating battery capacities among electrochemical characteristics of the positive electrode materials prepared according to Comparative Examples and Examples of the present disclosure, FIGS. 4A to 4D are graphs showing results of evaluating the battery capacities according to cycles of batteries using positive electrodes which are manufactured according to Comparative Examples and Examples of the present disclosure, and FIG. 5 is a graph showing comparison results of initial capacity retention rates according to the cycles of the batteries using the positive electrodes which are manufactured according to Comparative Examples and Examples of the present disclosure.

A positive electrode material for a lithium secondary battery according to an embodiment of the present disclosure is a material constituting a positive electrode applied to a lithium secondary battery and is a positive electrode active material made of a Li—[Mn—Ti]—O-based material so as to allow reversible intercalation and reversible deintercalation of lithium, and the positive electrode active material is characterized by being doped with a dopant (Me).

Conventionally, NCM811 which is an alloy material containing more than 80% nickel (Ni) having a high energy density and mixed with cobalt (Co), manganese (Mn), and aluminum (Al) is mainly used as a positive electrode material. However, a positive electrode material containing more than 80% Ni has a problem in that the positive electrode material is very sensitive in the atmosphere and is not easy to be synthesized.

Meanwhile, when a lithium excess material is used, a high capacity of 250 mAh/g or more may be implemented in a voltage range of 2 V to 4.2 V.

In addition, when a positive electrode active material made of a Li—[Mn—Ti]—O-based material is doped using a metal having bivalent to hexavalent oxidation numbers as a dopant, electron and ion conductivity may be increased and electrochemical performance may be improved through structural stability.

In this case, the reason why the dopant (Me) doped in the positive electrode active material is selected as a transition metal having bivalent to hexavalent oxidation numbers is as follows.

When a transition metal having a monovalent oxidation number such as Li₂O, Na₂O, and K₂O is doped in the positive electrode active material through a starting material and the oxidation number in a structure is considered, an amount of Li is increased so that there is a problem in that it is difficult to form a single-phase structure due to an excess of Li. In addition, since a transition metal of which an oxidation number exceeds hexavalent is not stably present, the transition metal is excluded from the dopant (Me).

Specifically, the positive electrode material doped with a transition metal may be expressed as Li_{1.25+y}[Mn_{0.45}Ti_{0.35}]₁₋ₓMeₓO₂, the dopant (Me) may be Al, and ranges of 0.025≤x≤0.05 and −0.02≤y≤0.02 are satisfied.

When the suggested atomic ratio or molar ratio, that is, x and y values are out of the proposed ranges, precipitation may occur due to an excess of Li, or a side reaction due to the excess of Li proceeds so that a lot of impurities may be generated.

The present disclosure will be described with respect to the positive electrode material, which is prepared as described above, through Examples and Comparative Examples.

### Preparation of Positive Electrode Material

### Comparative Example 1

Li₂CO₃ (a 3 wt % excess of Li₂CO₃ was put), Mn₂O₃ (Mn₂O₃ was sintered and synthesized), TiO₂, and WO₃ were mixed in an anhydrous ethanol solvent using a 45 ml Jar. In this case, a molar ratio of each component was adjusted according to a composition of Li_{1.2}[(Mn_{0.4}Ti_{0.4})_{0.95}W_{0.05}]O₂. In this case, ZrO₂ balls of 10 mm×5 g, 5 mm×10 g, and 1 mm×4 g were put. A ball milling condition was 300 rpm/5 h and was performed in seventeen sets, each fifteen minutes. After the ball milling, washing was performed using ethanol, drying was performed, and then pelletization was proceeded. Sintering was performed at a temperature of 900° C. for twelve hours in an Ar atmosphere to yield a powder.

Thereafter, first carbon ball milling (300 rpm/6 h and twenty sets, each fifteen minutes) [active material:acetylene black=9 wt %:1 wt %, and ZrO₂ ball: 10 mm×3 g, 5 mm×9 g, and 1 mm×2 g] was proceeded, and then second carbon ball milling (300 rpm/12 h and forty sets, each fifteen minutes) [ZrO₂ ball: 1 mm×5.5 g] was proceeded.

### Comparative Example 2

Comparative Example 2 was performed in the same manner as in Example 1, but a molar ratio of each component was adjusted according to a composition of Li_{1.2}[(Mn_{0.45}Ti_{0.35})]O₂.

### Example 1

Example 1 was performed in the same manner as in Example 2, and Al was adjusted to a ratio of 0.025 as the dopant (Me).

### Example 2

Example 2 was performed in the same manner as in Example 1, and Al was adjusted to a ratio of 0.05 as the dopant (Me).

The positive electrode active materials prepared through Comparative Examples and Examples were observed through XRD analysis, and the results were shown in FIG. 1.

The XRD analysis is a method of analyzing a pattern in which X-rays are diffracted from lattice planes formed by a regular arrangement of atoms constituting a solid sample to determine a phase and a crystal structure of the solid sample. As shown in FIG. 1, when compared with the positive electrode active materials prepared through Comparative Examples 1 and 2, it was confirmed that the positive electrode active materials prepared through Examples 1 and 2 exhibited very small movements on the graph and higher diffraction angles. In addition, it was confirmed that the prepared positive electrode active materials had structures of regular hexahedron and Fm-3 face-centered cubic system on the basis of a position of a peak.

FIG. 2 shows scanning electron microscope (SEM) photographs illustrating the positive electrode materials according to Examples and Comparative Examples of the present disclosure. Referring to the drawing, it can be seen that the positive electrode material using Al as a dopant proposed in the present disclosure has a form of an aggregated shape in which fine particles of 1 μm or less generally have a size of 3 μm or less.

Meanwhile, a half cell was manufactured through the following operations and test results of electrochemical characteristics using a Li metal as a negative electrode reference electrode were shown in FIGS. 3A to 5.

Manufacturing of Half Cell

Preparation of Slurry

All operations were performed in a glove box, polyvinylidene fluoride (PVdf) was used as a binder, and acetylene black was used as a conductive material. A slurry was prepared by mixing at a ratio of active material:conductive material:binder=85:5:10, and 45 μl of a solvent was put based on 0.1 g of a total material.

Coating after Mixing

Mixing was performed using mortar for ten minutes, and coating was performed at a thickness of 50 μm.

Drying was performed in a glove box of a vacuum oven at a temperature of 110° C., and a loading amount of an electrode was 1 mg based on 10Ø.

Manufacturing of Battery

All operations were performed in the glove box, a polyethylene (PE) separator was used as a separator, and an electrolyte in which 1M LiPF₆ was dissolved in a solvent mixed with EC:EMC=30:70 was used.

FIGS. 3A to 3D illustrate charging/discharge curves of batteries according to Comparative Examples and Examples that evaluate battery capacities using a 0.03 C-rate and a cut off condition ranging from 1.5 V to 4.8 V. It was confirmed that each of Comparative Examples 1 and 2, and Examples 1 and 2 had a discharge capacity having a value of 300 mAh/g or more, and the discharge capacity was observed in the order of Comparative Example 1<Comparative Example 2<Example 1<Example 2 so that it was seen that the battery of Example 2 doped with 5% Al had the discharge capacity of a largest value.

FIGS. 4A to 4D illustrate characteristics of cycle lifetimes of the batteries according to Comparative Examples and Examples, which are measured at a C-rate of 0.5 C, and FIG. 5 is a graph showing comparison results of initial capacity retention rates according to the cycles in accordance with Comparative Examples and Examples.

Since measurement was performed by changing the rate, the battery capacities exhibited different results from the values shown in FIGS. 3A to 3D, and it was confirmed that, when the measurement was performed at a condition of a 0.5 C-rate, Comparative Example 1 had a capacity that was smaller than 200 mAh/g and has a capacity of about 130 mAh/g in fifty cycles. It was confirmed that Comparative Example 2 had a capacity of more than 200 mAh/g and had a capacity of about 140 mAh/g in the fifty cycles. It was confirmed that Example 1 had a capacity that was smaller than 200 mAh/g and had a capacity of about 150 mAh/g in the fifty cycles. It was confirmed that Example 2 had a capacity that was smaller than 200 mAh/g and had a capacity of about 140 mAh/g in the fifty cycles.

Referring to FIG. 5, it was confirmed that, when the fifty cycles were repeated, the retention rate of the initial capacity exhibited in the order of Example 1 (74.8%)>Example 2 (72.2%)>Comparative Example 1 (70%)>Comparative Example 2 (68.7%).

That is, according to the above results, it can be seen that an effect of Al doping was insignificant in the discharge capacity, but there was a significant difference in the characteristics of lifetimes.

Specifically, it was confirmed that, in Comparative Example 1 and Comparative Example 2 of which contents of Mn and Ti differ, Comparative Example 2 having the same contents of Mn and Ti as in Example exhibited the discharge capacity that was greater than the discharge capacity of Comparative Example 1, but the characteristic of the lifetime of Comparative Example 2 was lower than the characteristic of the lifetime of Comparative Example 1 by as much as 1.3%. However, the characteristics of the lifetimes of Examples 1 and 2 doped with Al were increased by as much as 6.1% and 3.5%, respectively, when compared with the characteristic of the lifetime of Comparative Example 2.

Consequently, it can be seen that the discharge capacity was increased through a change in composition of Mn and Ti, but there was a problem of degrading the characteristic of the lifetime, and this problem was solved through doping of Al ranging from 2.5% to 5%.

Therefore, it can be confirmed that structural stability of the positive electrode active material was increased through Al doping so that the electrochemical characteristic was improved.

In accordance with the embodiments of the present disclosure, it is possible to form a positive electrode material which implements a discharge capacity that is greater than a discharge capacity of a conventional positive electrode without using Ni and Co, and thus by using the positive electrode material, an effect which is capable of implementing a positive electrode material having a high energy density can be expected.

In particular, the positive electrode active material is doped with a dopant (Me) containing Al so that an effect capable of overcoming atmospheric instability, structural instability, a low lifetime characteristic, and a low output characteristic of the positive electrode active material can be expected.

Therefore, a pure electric vehicle model can be constructed, a manufacturing cost of the pure electric vehicle can be reduced, and an effect applicable to a large-capacity power storage field and a transportation field can be expected.

Although the present disclosure has been described with reference to the accompanying drawings and the above-described exemplary embodiments, the present disclosure is not limited thereto and is limited by the appended claims. Therefore, modifications and alternations of the present disclosure can be devised by those skilled in the art without departing from the scope of the technical spirit of the appended claims.

1. A positive electrode material for a lithium (Li) secondary battery, wherein the positive electrode material is a positive electrode active material made of Li—[Mn—Ti]—O-based material to allow reversible intercalation and reversible deintercalation of Li, and the positive electrode active material is doped with a dopant (Me) having bivalent to hexavalent oxidation numbers.

2. The positive electrode material of claim 1, wherein:
the positive electrode material is Li_{1.25+y}[Mn_{0.45}Ti_{0.35}]₁₋ₓMeₓO₂;
the dopant (Me) is Al; and
0.025≤x≤0.05 and −0.02≤y≤0.02 are satisfied.

3. A lithium secondary battery, comprising:
a positive electrode including the positive electrode material for a lithium secondary battery according to claim 2;
a negative electrode including a negative electrode active material; and
an electrolyte.
